(19) United States
(12) Patent Application Publication
(10) Pub. No.: US 2026/0105533 A1
(43) Pub. Date: Apr. 16, 2026

(54) INFORMATION PROCESSING APPARATUS, SUPPORT METHOD, AND A NON-TRANSITORY RECORDING MEDIUM

(71) Applicant: NEC Corporation, Tokyo (JP)

(72) Inventors: Takuma SATO, Tokyo (JP); Daiki Sato, Tokyo (JP); Etsuko Ichihara, Tokyo (JP); Kenei Tanabe, Tokyo (JP); Fumihiro Taniguchi, Tokyo (JP)

(73) Assignee: NEC Corporation, Tokyo (JP)

(21) Appl. No.: 19/346,964

(22) Filed: Oct. 1, 2025

(30) Foreign Application Priority Data
Oct. 11, 2024 (JP) 2024-179343

(51) Int. Cl. G06Q 40/08

(52) U.S. Cl. CPC G06Q 40/09

(57) ABSTRACT

An information processing apparatus includes an acquisition unit that acquires notification information indicating a candidate item that may be associated with a notification item in an insurance contract, and an extraction unit that extracts a notification item related to the candidate item from a document in which the notification item of the insurance is described, using an extraction model. The information processing apparatus enables an applicant to be supported in making a decision in reporting a notification item.

### INCORPORATION BY REFERENCE

This application is based upon and claims the benefit of priority from Japanese patent application No. 2024-179343, filed on Oct. 11, 2024, the disclosure of which is incorporated herein in its entirety by reference.

### TECHNICAL FIELD

The present disclosure relates to an information processing apparatus, a support method, and a non-transitory recording medium.

### BACKGROUND ART

In contracting an insurance contract, an applicant of the insurance is required to notify predetermined notification item for each insurance. For example, in the case of life insurance, medical insurance, or the like, it is often required to notify the presence or absence of a specific disease or injury in the latest several years. In a case where a contract is made without announcing the fact associated with the notification item or a notification of a content different from the fact is made, the insurance contract may be cancelled as violation of the obligation of notification, and the insurance money or benefit may not be received. Therefore, it is important to accurately notify the necessary notification item without omission.

Examples of a technology for supporting notification for an insurance contract include a notification information providing system disclosed in JP 2023-092058 A. In the notification information providing system disclosed in JP 2023-092058 A, a sick/injured history determination master in which a sick/injured area which needs to be notified in acquiring an insurance is associated with a medical care act or medicine information associated with disease or injury is prepared in advance. Then, in this notification information providing system, by using the sick/injured history determination master and the information regarding the medical care act and the information regarding the medicine described in a claim form issued by the medical institution, information regarding the medical care act and the medicine associated with the predetermined sick/injured requiring notification is extracted.

### SUMMARY

The notification information providing system disclosed in JP 2023-092058 A is based on the premise that a sick/injured history determination master can be prepared in advance and necessary information can be acquired from a claim form. However, in practice, it is not easy to prepare a sick/injured history determination master for each of a wide variety of insurance products, and it is not always possible to acquire necessary information from a claim form.

For this reason, under the present circumstances, many applicants for insurance contracts apply for insurance by performing complicated work of comparing their own sick/injured history, which is likely to be associated with the notification item, with the notification item in the insurance they wish to contract, and confirming one by one whether the notification item. An example object of the present disclosure is to provide a technology for supporting easy notification of a notification item in an insurance contract.

An information processing apparatus according to an example aspect of the present disclosure includes: acquisition means for acquiring notification information indicating a candidate item likely to be associated with a notification item which is an item to be notified by an applicant of an insurance contract at the time of the contract; and extraction means for extracting a related notification item, which is a notification item related to the candidate item, from a document in which the notification item of the insurance is described using an extraction model machine learned in such a way as to output a portion related to the data in the document by using a set of the document and the data as an input.

An information processing apparatus according to an example aspect of the present disclosure includes: acquisition means for acquiring notification information indicating a candidate item likely to be associated with a notification item which is an item to be notified by an applicant of an insurance contract at the time of the contract; and determination means for determining whether the candidate item is associated with the notification item by using a language model trained by machine learning on natural language.

In a support method according to an example aspect of the present disclosure, at least one processor executes acquisition processing of acquiring notification information indicating a candidate item that may be associated with a notification item which is an item to be notified by an applicant of an insurance contract at the time of a contract, and extraction processing of extracting a related notification item, which is a notification item related to the candidate item, from a document in which a notification item of the insurance is described using an extraction model machine learned in such a way as to output a portion related to the data in the document using a set of the document and the data as an input.

A support program according to an example aspect of the present disclosure causes a computer to function as acquisition means for acquiring notification information indicating a candidate item that may be associated with a notification item which is an item to be notified by an applicant of an insurance contract at the time of a contract, and extraction means for extracting a related notification item, which is a notification item related to the candidate item, from a document in which a notification item of the insurance is described using an extraction model machine learned in such a way as to output a portion related to the data in the document using a set of the document and the data as an input.

According to an exemplary aspect of the present disclosure, there is an exemplary effect that it is possible to support easy notification of a notification item in an insurance contract.

### BRIEF DESCRIPTION OF DRAWINGS

FIG. 1 is a block diagram illustrating a configuration of an information processing apparatus according to the present disclosure;

FIG. 2 is a flowchart illustrating a flow of a support method according to the present disclosure;

FIG. 3 is a block diagram illustrating a configuration of another information processing apparatus according to the present disclosure;

FIG. 4 is a diagram illustrating an extraction example of related notification items;

FIG. 5 is a diagram illustrating an example of determining whether a candidate item is associated with related notification items;

FIG. 6 is a diagram illustrating an example of a user interface (UI) screen that receives a correction instruction in a natural language;

FIG. 7 is a diagram illustrating an example of a UI screen to be presented for prompting confirmation of input omission;

FIG. 8 is a diagram illustrating an example of a UI screen that receives an input of an explanatory sentence of history information;

FIG. 9 is a flowchart illustrating a flow of processing executed by the information processing apparatus illustrated in FIG. 3;

FIG. 10 is a block diagram illustrating a configuration of an information processing apparatus according to a reference example; and

FIG. 11 is a block diagram illustrating a configuration of a computer that functions as an information processing apparatus according to the present disclosure.

### EXAMPLE EMBODIMENT

Hereinafter, example embodiments of the present invention will be described. However, the present invention is not limited to the exemplary example embodiments to be described below, and various modifications can be made within the scope described in the claims. For example, example embodiments obtained by appropriately combining techniques (some or all of things or methods) adopted in the following exemplary example embodiments can also be included in the scope of the present invention. Example embodiments obtained by appropriately omitting some of the techniques adopted in the following exemplary example embodiments can also be included in the scope of the present invention. Effects mentioned in the following exemplary example embodiments are examples of effects expected in the exemplary example embodiments, and do not define extensions of the present invention. That is, example embodiments that do not achieve the effects mentioned in the following exemplary example embodiments can also be included in the scope of the present invention.

### First Exemplary Example Embodiment

A first exemplary example embodiment that is an example of an example embodiment of the present invention will be described in detail with reference to the drawings. The present exemplary example embodiment is a basic form of each exemplary example embodiment to be described below. An application range of each technique adopted in the present exemplary example embodiment is not limited to the present exemplary example embodiment. That is, each technique adopted in the present exemplary example embodiment can also be adopted in the other exemplary example embodiments included in the present disclosure within a range in which no particular technical problem occurs. Each technique illustrated in the drawings referred to for describing the present exemplary example embodiment can also be adopted in the other exemplary example embodiments included in the present disclosure within a range in which no particular technical problem occurs.

### Configuration of Information Processing Apparatus 1

A configuration of an information processing apparatus 1 according to the present exemplary example embodiment will be described with reference to FIG. 1. FIG. 1 is a block diagram illustrating a configuration of the information processing apparatus 1. As illustrated in FIG. 1, the information processing apparatus 1 includes an acquisition unit 101 and an extraction unit 102.

The acquisition unit 101 acquires notification information indicating candidate item that may be associated with notification items that are to be notified by an applicant of an insurance contract at the time of the contract.

Here, the “insurance” described above may be any insurance that defines a notification item. For example, the insurance described above may be an insurance related to the life or health of an insured person such as a life insurance, an endowment insurance, or a medical insurance, or may be an insurance related to owned property such as an automobile insurance or a fire insurance.

The above-described “notification items” are items that are subject to an obligation to notify. Generally, if the insurer knows the circumstances, a circumstance that is objectively recognized as not entering into a contract or not entering into a contract under at least the same conditions is a notification item. For example, in the case of an insurance related to the life or health of an insured person, such as a life insurance, the current health state or the past medical history of the insured person is regarded as a notification item.

The “notification information” may indicate at least one candidate item that may be associated with the notification item. For example, the acquisition unit 101 may acquire, as the notification information, text data listing item considered by the applicant to possibly be associated with the notification item.

For example, the acquisition unit 101 may acquire history information on sickness or injury of the applicant as the notification information. The history information may be any information as long as it indicates the history of the applicant, which may be related to the notification item. For example, the acquisition unit 101 may acquire history information indicating, in addition to history of sickness or injury (which may include a current health condition) of the applicant, whether the applicant regularly visits a hospital, a history of prescribed medicine, a health checkup result, an examination result by a doctor, a medical examination result, a health care recipient history, and the like.

Any method of acquiring the notification information is applied. The acquisition unit 101 may acquire a plurality of types of notification information. For example, the acquisition unit 101 may acquire both text data input by the applicant and history information recorded in a predetermined database (for example, a database in which various types of information regarding medical insurance and the like are recorded in association with individual identification information allocated to each of the people) as the notification information.

The extraction unit 102 extracts a notification item related to the candidate item indicated in the notification information acquired by the acquisition unit 101 from the document in which the notification item of the insurance is described using an extraction model machine learned in such a way as to output a portion related to the data in the document using a set of the document and the data as an input. Since the notification item extracted by the extraction unit 102 is a notification item related to the candidate item, this notification item is hereinafter referred to as a related notification item.

The “extraction model” described above may be any model that can be used to extract a related notification item from a document in which an insurance notification item is described. For example, a model that divides a document in which a notification item is described into texts in a predetermined unit (for example, for each sentence or for each notification item), calculates a score indicating similarity of the content with the candidate item for each text obtained by the division, and outputs a text in which the calculated score is equal to more than a predetermined threshold can be used as the extraction model. Such a model can be generated, for example, by machine learning using training data in which the score in a set of text and data is associated as ground truth data with respect to the set of text and data. The data paired with the text is typically text data, but it is also possible to use data in another format such as image data.

The “extraction model” described above may be a general-purpose model that can be used for applications other than extraction of related notification item, or may be a model obtained by fine-tuning a general-purpose model for extraction of related notification item. The extraction model may be included in the information processing apparatus 1 or may be included in another apparatus. In the latter case, the extraction unit 102 uses the extraction model via another device including the extraction model.

The “document describing the notification item of the insurance” may be a document describing at least a part of the notification item of the insurance that the applicant intends to contract with. For example, an application form, an instruction, a contract term, or the like of the insurance can be used as a document describing notification item of the insurance.

As described above, the information processing apparatus 1 according to the present exemplary example embodiment includes: the acquisition unit 101 for acquiring notification information indicating a candidate item likely to be associated with a notification item which is an item to be notified by an applicant of an insurance contract at the time of the contract; and the extraction unit 102 for extracting a related notification item, which is a notification item related to the candidate item, from a document in which the notification item of the insurance is described using an extraction model machine learned in such a way as to output a portion related to the data in the document by using a set of the document and the data as an input.

Since the related notification item extracted as described above is related to the candidate item, it can be said that there is a high possibility that the item should be notified by the applicant among the notification item described in the document in which the notification item is described. The notification information necessary for extracting the related notification item may indicate any candidate item that may be associated with the notification item, and may indicate, for example, a candidate item that an insurance applicant cannot have confidence that it is associated with the notification item.

That is, according to the above configuration, it is possible to extract the related notification item that is highly likely to be the item to be notified by the applicant based on the candidate item that the applicant of the insurance cannot have confidence that it is associated with the notification item. Therefore, according to the information processing apparatus 1, it is possible to obtain an effect of being able to support the notification of the notification item in the insurance contract in such a way as to be easily performed. According to the information processing apparatus 1, it is also possible to support the determination made in a case where the applicant reports the notification item, that is, the determination as to whether to notify the candidate item as the notification item.

Any method of using the extracted related notification item in facilitating the notification is applicable. For example, the information processing apparatus 1 may present the extracted related notification item to the applicant as reference information. In this case, the applicant can determine whether to notify the candidate item with reference to the presented related notification item. For example, as described in a second exemplary example embodiment to be described later, it may be determined whether the above candidate item is associated with a related candidate item, and the candidate item determined to be associated with the related candidate item may be presented as a notification item by the applicant.

### Support Program

The functions of the information processing apparatus 1 described above can also be achieved by a program. A support program according to the present exemplary example embodiment is a support program for application of an insurance contract, and causes a computer to function as acquisition means for acquiring notification information indicating a candidate item that may be associated with a notification item which is an item to be notified by an applicant of an insurance contract at the time of a contract, and extraction means for extracting a related notification item, which is a notification item related to the candidate item, from a document in which a notification item of the insurance is described using an extraction model machine learned in such a way as to output a portion related to the data in the document using a set of the document and the data as an input. According to this support program, it is possible to obtain an effect that it is possible to support the notification of the notification item in the insurance contract in such a way as to be easily notified.

### Flow of Support Method

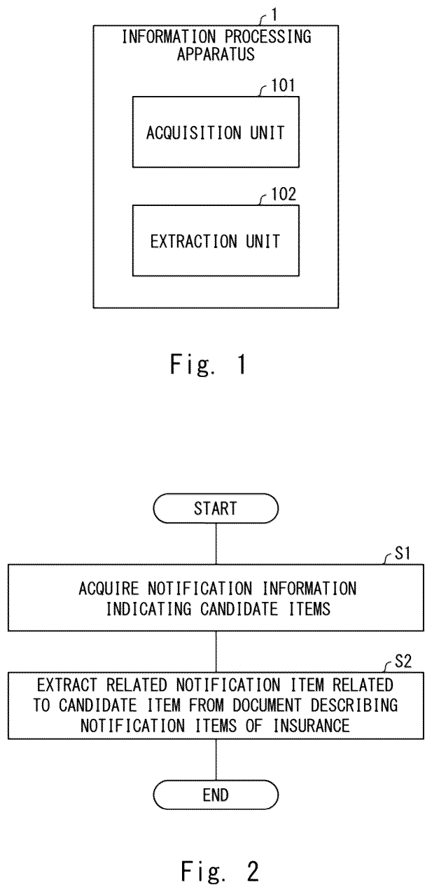

A flow of a support method according to the present exemplary example embodiment will be described with reference to FIG. 2. FIG. 2 is a flowchart illustrating a flow of the support method. An executing entity of each step in this support method may be a processor included in the information processing apparatus 1, may be a processor included in another apparatus, or an executing entity of each step may be a processor provided in each of different apparatuses.

In S1 (acquisition processing), at least one processor acquires notification information indicating candidate items that may be associated with notification items that an applicant for an insurance contract should notify at the time of the contract.

In S2 (extraction processing), at least one processor extracts a related notification item, which is a notification item related to the candidate item indicated in the notification information acquired in S1, from the document in which the notification items of the insurance are described using an extraction model machine learned in such a way as to output a portion related to the data in the document by using the set of document and data as an input.

As described above, the support method according to the present exemplary example embodiment is a support method for application of an insurance contract, in which at least one processor executes: acquisition processing for acquiring notification information indicating a candidate item that may be associated with a notification item that is an item to be notified by an applicant of the insurance contract at the time of the insurance contract; and an extraction processing of extracting a related notification item that is a notification item related to the candidate item from a document in which the notification item of the insurance is described, using an extraction model machine learned in such a way as to output a portion related to the data in the document by using a set of document and data as an input. According to this support method, it is possible to obtain an effect that support can be performed in such a way that notification of a notification item in an insurance contract can be easily performed.

### Second Exemplary Example Embodiment

A second exemplary example embodiment that is an example embodiment of the present invention will be described in detail with reference to the drawings. Components having the same functions as the components described in the above-described exemplary example embodiment will be denoted by the same reference numerals, and the description thereof will be appropriately omitted. An application range of each technique adopted in the present exemplary example embodiment is not limited to the present exemplary example embodiment. That is, each technique adopted in the present exemplary example embodiment can also be adopted in the other exemplary example embodiments included in the present disclosure within a range in which no particular technical problem occurs. Each technique illustrated in each of the drawings referred to for describing the present exemplary example embodiment can be employed in the other exemplary example embodiments included in the present disclosure within the scope in which no particular technical problem occurs.

### Configuration of Information Processing Apparatus 1A

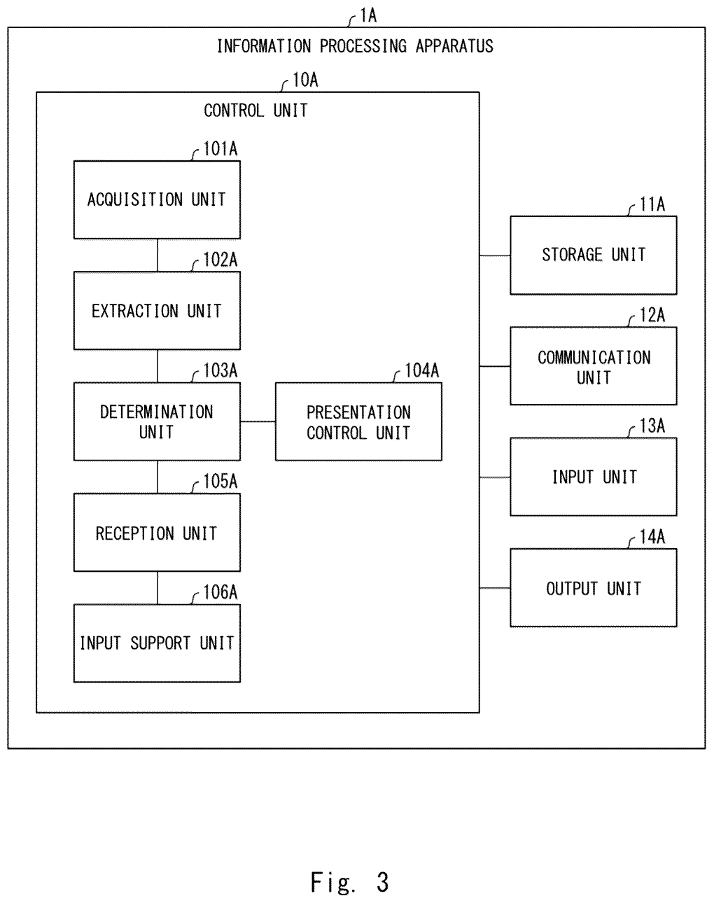

A configuration of an information processing apparatus 1A according to the present exemplary example embodiment will be described with reference to FIG. 3. FIG. 3 is a block diagram illustrating the configuration of the information processing apparatus 1A. The information processing apparatus 1A is an apparatus having a function of supporting application for an insurance contract. The information processing apparatus 1A may be a local apparatus used by individual users, or may be a server that provides application support services for insurance contracts to a plurality of users.

As illustrated, the information processing apparatus 1A includes a control unit 10A that integrally controls units of the information processing apparatus 1A, and a storage unit 11A that stores various types of data to be used by the information processing apparatus 1A. The information processing apparatus 1A includes a communication unit 12A for the information processing apparatus 1A to communicate with another apparatus, an input unit 13A that receives an input to the information processing apparatus 1A, and an output unit 14A for the information processing apparatus 1A to output data. Then, the control unit 10A includes an acquisition unit 101A, an extraction unit 102A, a determination unit 103A, a presentation control unit 104A, a reception unit 105A, and an input support unit 106A.

Similarly to the acquisition unit 101 of the first exemplary example embodiment, the acquisition unit 101A acquires notification information indicating candidate item that may be associated with notification item that are to be notified by an applicant of an insurance contract at the time of the contract. The acquisition unit 101A may also acquire various types of information (for example, attribute information of the applicant such as a name and a date of birth) that need to be input for the insurance contract other than the notification item.

Similarly to the extraction unit 102 of the first exemplary example embodiment, the extraction unit 102A extracts a related notification item, which is a notification item related to the candidate item, from the document in which the notification item of the insurance is described using an extraction model machine learned in such a way as to output a portion related to the data in the document by using a set of the document and the data as an input. Hereinafter, the extraction model used by the extraction unit 102A is referred to as an extraction model M1.

The determination unit 103A determines whether the candidate item indicated in the notification information acquired by the acquisition unit 101A is associated with a notification item by using a language model trained by machine learning on natural language. More specifically, the determination unit 103A determines whether the candidate item indicated in the notification information acquired by the acquisition unit 101A is associated with the related notification item extracted by the extraction unit 102A.

However, the extraction of the related notification item by the extraction unit 102A is not an essential premise in the determination by the determination unit 103A. For example, the determination unit 103A may perform processing of determining whether the candidate item indicated in the notification information acquired by the acquisition unit 101A is associated with the notification item of the insurance that the applicant intends to subscribe to for each of the notification item of the insurance. Although the number of times of determination by the determination unit 103A is increased as compared with the case of extracting the related notification item, even in a case where such processing is adopted, it is possible for the applicant to specify the notification item.

Here, machine learning on natural language more specifically means learning of the arrangement of components (words and the like) in a sentence in a natural language and the arrangement of sentences in a text. Examples of the language model trained on natural language include bidirectional encoder representations from transformers (BERT), Robustly optimized BERT approach (RoBERTa), efficiently learning an encoder that classifies token replacements accurately (ELECTRA), and the like. Hereinafter, the language model used by the determination unit 103A is referred to as a language model M2.

In the present exemplary example embodiment, an example in which the language model M2 is a model that accepts an input of a prompt in a text format described in a natural language and outputs an answer in the natural language will be described. However, the language model M2 may be a model capable of receiving input of data in a format other than text data such as an image.

The language model M2 may be a general-purpose language model that can be used for applications other than the inference of whether the candidate item is associated with the notification item, or may be a language model obtained by fine-tuning a general-purpose language model for the inference of whether the candidate item is associated with the notification item. The language model M2 may be included in the information processing apparatus 1A or may be included in another apparatus. In the latter case, the determination unit 103A uses the language model M2 via another device including the language model M2.

The presentation control unit 104A presents various types of information regarding application support for an insurance contract. For example, the presentation control unit 104A presents the candidate item determined to be associated with the related notification item by the determination unit 103A as an item to be notified by the applicant. For example, the presentation control unit 104A presents the inference result output by the language model M2. Although details will be described later, the presentation control unit 104A may present the inference result together with the basis of the inference. Any method of presenting the information is applicable. For example, the presentation control unit 104A may present information by causing the output unit 14A to output the information, or may present information by causing another device to output the information via the communication unit 12A. The information can be presented in any form such as display, printing, voice, or a combination thereof.

The reception unit 105A receives various instructions regarding application support for an insurance contract. For example, the reception unit 105A receives a correction instruction for a result of inference by the language model M2. Any method of receiving the instruction is applicable. For example, the reception unit 105A may receive an instruction input via the input unit 13A, or may receive an instruction from another device via the communication unit 12A.

The input support unit 106A supports input of various item required to be input by the applicant in proceeding with the insurance contract. For example, the input support unit 106A inputs the candidate item determined to be associated with the related notification item by the determination unit 103A to the input field of the notification item in the input form of the insurance to be contracted by the applicant.

Since the determination result of the determination unit 103A is not necessarily correct, it is possible to present the candidate item to the applicant and have him/her check for errors before entering the item into the input form. It is not essential to provide the input support unit 106A. In a case where the input support unit 106A is not provided, the applicant may perform input into the input form or fill in the application form with reference to candidate item (candidate item determined to be associated with related notification item) presented by the presentation control unit 104A.

As described above, the information processing apparatus 1A includes: the acquisition unit 101A that acquires notification information indicating a candidate item that may be associated with a notification item that is an item to be notified by an applicant of an insurance contract at the time of the contract; and the extraction unit 102A that extracts a related notification item, which is a notification item related to the candidate item, from a document in which the notification item of the insurance is described, using the extraction model M1 machine learned in such a way as to output a portion related to the data in the document by using a set of document and data as an input. Therefore, according to the information processing apparatus 1A, similarly to the information processing apparatus 1, it is possible to obtain an effect of being able to support the notification of the notification item in the insurance contract in such a way as to be easily performed.

As described above, the information processing apparatus 1A includes: the determination unit 103A that determines whether a candidate item is associated with a related notification item by using the language model M2 trained by machine learning on natural language; and the presentation control unit 104A that presents the candidate item determined to be associated with the related notification item by the determination unit 103A as an item to be notified by the applicant. As a result, in addition to the effect obtained by the information processing apparatus 1, it is possible to cause the applicant to recognize the candidate item to be notified and to smoothly perform notification.

The determination by the determination unit 103A can be omitted. In a case where the determination by the determination unit 103A is omitted, the presentation control unit 104A may present the related notification item extracted by the extraction unit 102A. In this case, the applicant may compare the presented related notification item with the candidate item and determine whether to notify the candidate item. As a result, it is possible to save the time and effort of the applicant who searches for the notification item related to the candidate item from the document defining the notification item and to facilitate the notification.

As described above, the information processing apparatus 1A includes the acquisition unit 101A that acquires notification information indicating a candidate item that may be associated with a notification item that is an item to be notified by an applicant of an insurance contract at the time of the contract, and the determination unit 103A that determines whether the candidate item indicated in the notification information acquired by the acquisition unit 101A is associated with the notification item, using a language model trained by machine learning on natural language. According to the information processing apparatus 1A, it is possible to obtain an objective determination result as to whether a candidate item is associated with a notification item. Therefore, it is possible to obtain an effect that it is possible to support the notification of the notification item in the insurance contract in such a way as to be easily notified.

### Exemplary Extraction of Related Notification Item

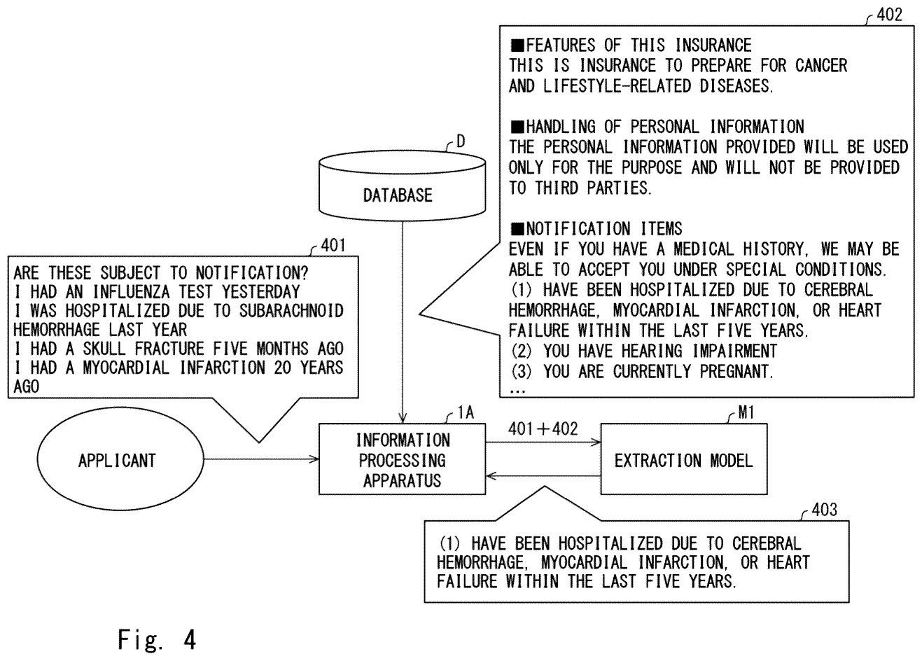

An example of extraction of related notification item by the information processing apparatus 1A will be described with reference to FIG. 4. FIG. 4 is a diagram illustrating an example of extraction of related notification item. In the example of FIG. 4, an applicant of an insurance contract inputs notification information 401 to the information processing apparatus 1A. The input notification information 401 is acquired by the acquisition unit 101A included in the information processing apparatus 1A.

The notification information 401 is a list of a plurality of item that the applicant considers as possibly associated with the notification item, that is, the above-described candidate item. The notification information 401 is a content asking whether these candidate items are to be notified, in other words, whether these items are associated with the notification item. For example, the applicant may input the notification information 401 via the input unit 13A, or may input the notification information 401 via the communication unit 12A using his/her own terminal device or the like. The applicant may input the notification information 401 as text data or as voice data. In the latter case, the acquisition unit 101A can acquire the notification information 401 in a text format by causing the information processing apparatus 1A or another voice recognition apparatus to perform voice recognition on the input voice data.

In the example of FIG. 4, the information processing apparatus 1A (more specifically, the acquisition unit 101A) acquires, from the database D, a document 402 in which a notification item in the insurance that the applicant intends to subscribe to is described. In a case where the document 402 is configured to be acquired from the database D, a document in which a notification item of various types of insurance is described may be recorded in the database D in association with identification information of the insurance. Then, the information processing apparatus 1A may be caused to input identification information of the insurance that the applicant intends to subscribe. As a result, the acquisition unit 101A can acquire, from the database D, the document 402 in which a notification item in the insurance that the applicant intends to subscribe to is described. Any method of acquiring the document 402 is applicable, and is not limited to the above example. For example, the applicant may input the document 402 to the information processing apparatus 1A together with the notification information 401, or the document 402 may be stored in the information processing apparatus 1A in advance.

Next, the information processing apparatus 1A (more specifically, the extraction unit 102A) inputs the notification information 401 and the document 402 acquired by the acquisition unit 101A as described above to the extraction model M1. As a result, the related notification item 403 is output from the extraction model M1.

The related notification item 403 is a notification item related to at least one of a plurality of candidate items indicated in the notification information 401 among the notification items specified in the document 402. Specifically, the related notification item 403 indicates a notification item that “(1) Have been hospitalized due to cerebral hemorrhage, myocardial infarction, or heart failure within the last five years. ” related to candidate item of “I was hospitalized due to subarachnoid hemorrhage last year” and “I had myocardial infarction 20 years ago”indicated in the notification information 401.

Although details will be described below, the determination unit 103A determines whether the candidate item indicated in the notification information 401 is associated with the related notification item 403 extracted as described above. As described above, the presentation control unit 104A may present the extracted related notification item 403 to the applicant. In this case, the presentation control unit 104A may cut out and present a portion of the related notification item 403 from the document 402, or may present a document 402 in which a portion of the related notification item 403 is highlighted. The highlight may be performed in a mode in which the highlighted portion and the non-highlighted portion can be identified. For example, the presentation control unit 104A may highlight the portion of the related notification item 403 in the document 402 by changing the background color of the highlight part, changing the character font of the highlight part, or the like.

### Example of Determination as to Whether Candidate Item is Associated with Related Notification Item

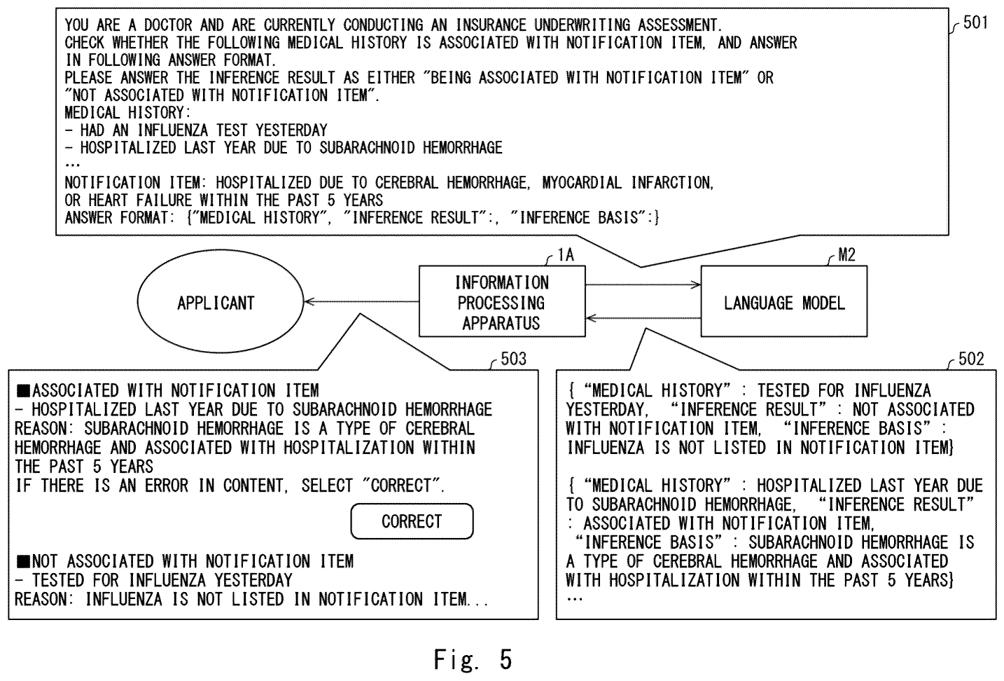

FIG. 5 is a diagram illustrating an example of determining whether a candidate item is associated with a related notification item. As described above, this determination is performed by the determination unit 103A. A language model M2 is used for this determination. Therefore, the determination unit 103A generates a prompt describing the content of the instruction for the language model M2 and inputs the prompt to the language model M2.

In the example of FIG. 5, the information processing apparatus 1A (more specifically, the determination unit 103A) inputs a prompt 501 to the language model M2. The prompt 501 includes the related notification item 403 shown in FIG. 4 and each candidate item shown in the notification information 401 shown in FIG. 4, and instructs to infer a relationship between the related notification item 403 and the candidate item.

More specifically, each candidate item indicated in the notification information 401 is described in the item of “medical history” in the prompt 501. The related notification item 403 is described in the item of “notification item” in the prompt 501. The prompt 501 includes a sentence “You are a doctor and are currently conducting an insurance underwriting assessment. ”. It is not essential to include such a sentence, but the inference accuracy can be expected to be improved by including such a sentence.

The prompt 501 is a content instructing to check whether the medical history can be inferred to be associated with the notification item. The expression in the prompt can be appropriately changed within a range in which a desired inference result can be obtained. For example, the determination unit 103A may generate a prompt having a different expression of the inference instruction according to a target candidate item, a type of insurance, a language model to be used, and the like.

The prompt 501 includes an “answer format” and has contents instructing to answer in this answer format. In this way, by specifying the answer format, it is possible to obtain an inference result in a desired format. This answer format includes an item “inference basis”. By including such items, it is possible to cause the language model M2 to output the inference result and the grounds of the inference. The instruction to output the grounds of inference may be made by including a text such as “Please answer the grounds together with the inference result” in the prompt, for example.

The prompt 501 may include a text specifying an output condition. For example, a sentence such as “It is necessary to infer whether all texts of the medical history are associated with the notification item. ” or “The number of elements included in the answer format needs to match the number of sentences of the medical history. ” may be included in the prompt 501. This makes it possible to enhance the inference accuracy of the language model M2.

In the prompt 501, contents other than “medical history” and “notification item” are fixed. For this reason, a portion other than the contents of the “medical history” and the “notification item” in the prompt 501 may be stored in the storage unit 11A or the like as a fixed template. As a result, the determination unit 103A can generate the prompt 501 by inputting the candidate item indicated in the notification information 401 acquired by the acquisition unit 101A and the related notification item 403 extracted by the extraction unit 102A to the template.

The inference result 502 illustrated in FIG. 5 illustrates an example of an inference result obtained by inputting the prompt 501 to the language model M2. The inference result 502 indicates a result of inferring the relationship between the related notification item and the candidate item in the form of an answer format indicated in the prompt 501. Specifically, the inference result 502 indicates, for each candidate item indicated in the notification information 401, an inference result indicating that the candidate item “is associated with a notification item” or “is not associated with a notification item”. In the inference result 502, the inference result of each candidate item and the basis of the inference are indicated.

The prompt 501 in FIG. 5 is a prompt for collectively determining whether a plurality of candidate items is associated with the related notification item 403, but a prompt for determining whether each candidate item is associated with the related notification item 403 may be used. In this case, for one candidate item, the determination unit 103A may perform processing of inputting the candidate item and the related notification item 403 into the language model M2 and determining whether the candidate item is associated with the related notification item 403 for each candidate item.

In a case where a plurality of related notification item is extracted, the determination unit 103A may generate a prompt that includes a plurality of related notification item and a plurality of candidate items and instructs to infer a relationship (for example, whether it is associated with a related notification item, and if applicable, which related notification item it is associated with) between each candidate item and each related notification item. In this case, the determination unit 103A may generate a prompt similar to the prompt 501 of FIG. 5 for each related notification item, and cause inference of a relationship with each candidate item for each related notification item. The determination unit 103A may perform, for each of the plurality of candidate items, processing of inputting one of the related notification items and the candidate item to the language model M2 and determining whether the candidate item is associated with the related notification item for one of the plurality of related notification items. The determination unit 103A can determine which related notification item each candidate item is associated with (or is not associated with any related notification item) by performing such processing on each related notification item.

In what form the inference result is output can be specified by a prompt. For example, the determination unit 103A may generate a prompt for instructing to answer with three choices of “being associated with the notification item”, “neutral” and “not associated with the notification item”. In this case, in a case where an answer that a certain candidate item belongs to a certain notification item is output, the determination unit 103A may determine that the candidate item is associated with the notification item. What kind of processing is to be performed in a case where a neutral response is output may be determined in advance. For example, in a case where an answer of neutrality is output in response to a prompt asking whether a certain candidate item is associated with a certain related notification item, the presentation control unit 104A may present a combination of the candidate item and the related notification item to the applicant and cause the applicant to input whether the candidate item is associated with the related notification item. For example, the determination unit 103A may generate a prompt for instructing to output a numerical value (for example, a numerical value of 0 to 1) indicating the degree of possibility of being associated with the related notification item. In this case, in a case where a numerical value output for a combination of a certain candidate item and a certain related notification item is equal to or more than a predetermined threshold, the determination unit 103A may determine that the candidate item is associated with the related notification item.

FIG. 5 illustrates a screen example 503 which is an example of a UI screen for presenting the inference result 502. In the screen example 503, an inference result as to whether each candidate item is associated with a related notification item is presented together with the inference basis. The presentation control unit 104A can generate and present a UI screen such as the screen example 503 by using various types of information indicated in the inference result 502. In this manner, the presentation control unit 104A may present the candidate item determined to be associated with the related notification item by the determination unit 103A to the applicant as an item to be notified by the applicant. As described above, the presentation control unit 104A may present the inference basis output by the language model M2 to the applicant as a determination material for determining whether the inference result is appropriate.

In a case where the output unit 14A has a function of displaying and outputting an image, the presentation control unit 104A may cause the output unit 14A to display a UI screen. The presentation control unit 104A may cause a display device (for example, a display device included in a terminal device used by an applicant) outside the information processing apparatus 1A to display the UI screen via the communication unit 12A.

The screen example 503 has a specification that accepts a correction instruction for an inference result. Specifically, in the screen example 503, a text prompting selection of a “correct” button is illustrated if there is an error in the inference result, and the button (software key) for correcting the inference result is displayed. The button may be displayed for each of the inference results of the plurality of candidate items.

In a case where the operation of selecting the “correct” button is performed, the reception unit 105A receives the operation and notifies the determination unit 103A of the reception. Upon receiving this notification, the determination unit 103A changes the determination result of the target candidate item. That is, in a case where an instruction to correct an inference result that a certain candidate item “associated with a notification item” is received, the determination unit 103A changes the determination result of the candidate item to “not associated with a notification item”. Similarly, in a case where an instruction to correct an inference result that a certain candidate item “not associated with a notification item” is received, the determination unit 103A changes the determination result of the candidate item to “is associated with a notification item”.

As described above, the determination unit 103A may generate the prompt 501 that includes the related notification item and the candidate item and instructs to infer the relationship between the related notification item and the candidate item, and determine whether the candidate item is associated with the related notification item based on the inference result 502 that is an output obtained by inputting the generated prompt 501 into the language model M2. This makes it possible to appropriately determine whether the candidate item is associated with the related notification item.

### Presentation and Re-Inference of Inference Result

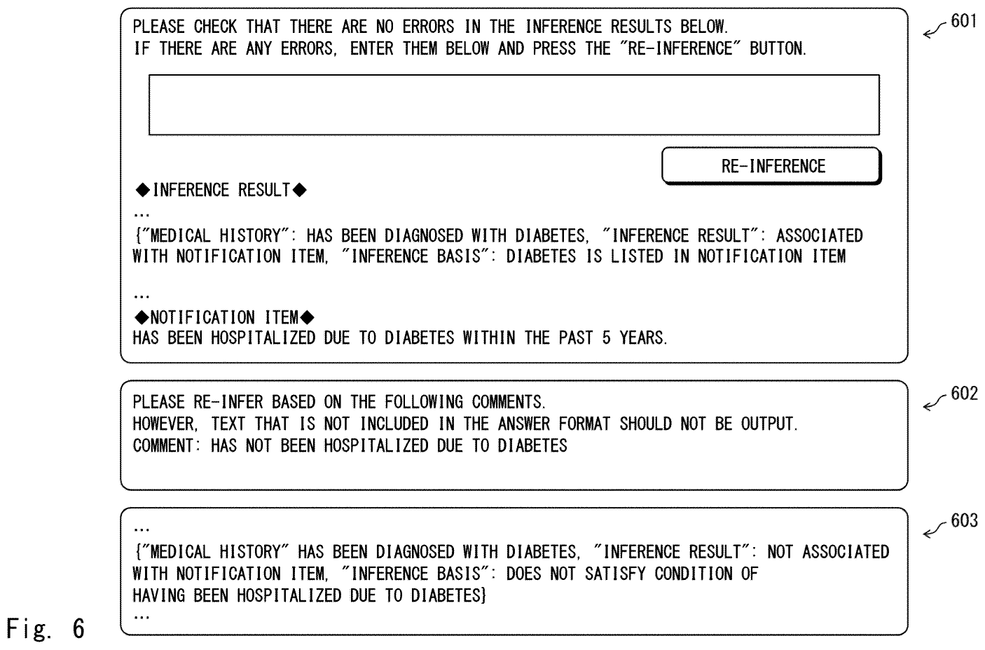

The reception unit 105A may receive a correction instruction representing a correction content in a natural language for the inference result. This will be described with reference to FIG. 6. FIG. 6 is a diagram illustrating an example of a UI screen that receives a correction instruction in a natural language. FIG. 6 also illustrates a prompt 602 for instructing re-inference based on a correction instruction in a natural language and a re-inference result 603 obtained by inputting the prompt 602 to the language model M2, in addition to the screen example 601 which is an example of a UI screen for receiving a correction instruction in a natural language.

In the screen example 601, an inference result of the language model M2 and a notification item (related notification item) which is a target of the inference are illustrated, and at the same time, a text requesting to confirm whether there is an error in the inference result and to instruct the re-inference by inputting the content of the error is illustrated. In the screen example 601, a text box for inputting the correction content and a button (software key) for instructing re-inference are also displayed.

The presentation control unit 104A presents a UI screen such as the screen example 601 to the applicant in such a way that the applicant can confirm the inference result. The reception unit 105A can also receive correction for the inference result via a UI screen such as the screen example 601.

In the screen example 601, in a case where a correction content is input to a text box and a button for instructing re-inference is operated, the reception unit 105A receives the input correction content as a correction instruction. For example, the reception unit 105A may receive a correction instruction in which the reason why the inference result is an error is described in a natural language. For example, the reception unit 105A may receive a correction instruction in which whether the candidate item to be inferred is associated with a related notification item is described in natural language.

Then, the determination unit 103A redetermines whether the candidate item is associated with the related notification item based on the correction instruction received by the reception unit 105A. For example, the determination unit 103A may generate a prompt 602 illustrated in FIG. 6, input the prompt to the language model M2, and redetermine whether the candidate item is associated with the related notification item based on the re-inference result 603 output from the language model M2.

The prompt 602 includes the text of the correction instruction received by the reception unit 105A, and is a prompt to instruct to infer the relationship between the candidate item and the related notification item based on the correction instruction. The prompt 602 includes a text “However, text that is not included in the answer format should not be output. ”. In this manner, the prompt for instructing re-inference may also include a text specifying an output condition. As a result, it is possible to prevent unnecessary content (for example, text such as “Sorry. I will output again. ” and “Contents have been updated. ”) from being output from the language model M2, and to prevent trouble from occurring in input to the input form of the insurance, and the like. The prompt 602 can also be generated using a predetermined template similarly to the prompt 501 illustrated in FIG. 5. A list of medical histories (candidate items), related notification item, an answer format, and the like may also be described in the prompt 602, similarly to the prompt 501.

In the re-inference result 603 illustrated in FIG. 6, the inference result of the relationship between the candidate item and the related notification item is changed from that illustrated on the UI screen 601 by reflecting the “comment” indicated in the prompt 602, that is, the content of the correction instruction. Specifically, in the re-inference result 603, the inference result as to whether the candidate item of “having been hospitalized due to diabetes” is associated with the related notification item is changed to “not associated with the notification item”. The inference basis has been changed to a sentence “does not satisfy condition of having been hospitalized due to diabetes”. As described above, the re-inference is performed using the prompt 602 including the sentence in the natural language received as the correction instruction, in such a way that the re-inference result 603 reflecting the content of the correction instruction can be output.

As described above, the determination unit 103A may generate a prompt (for example, the prompt 501 in FIG. 5) instructing to output a basis of the inference together with the inference result of the relationship between the related notification item and the candidate item. Then, the presentation control unit 104A may present the inference result output by the language model M2 together with the basis. As a result, in addition to the effect obtained by the information processing apparatus 1, it is possible to obtain an effect that the appropriateness/inappropriateness of the inference result of the language model M2 can be examined using the basis thereof as a determination material. The presentation control unit 104A may present the determination result of the determination unit 103A together with the above grounds instead of the inference result output by the language model M2.

As described above, the information processing apparatus 1A includes the reception unit 105A that receives a correction instruction for the inference result. Then, the determination unit 103A redetermines whether the candidate item is associated with the related notification item based on the correction instruction received by the reception unit 105A. As a result, in addition to the effect obtained by the information processing apparatus 1, it is possible to correct an error in the inference result in such a way that correct notification can be performed for the applicant.

As described above, the reception unit 105A may receive a correction instruction representing a correction content in a natural language. In this case, the determination unit 103A generates a prompt (for example, the prompt 602 in FIG. 6) including the correction instruction received by the reception unit 105A and instructing to infer the relationship between the candidate item and the related notification item based on the correction instruction, and redetermines whether the candidate item is associated with the related notification item based on the output obtained by inputting the generated prompt to the language model M2. As a result, in addition to the effect obtained by the information processing apparatus 1, it is possible to obtain an effect that appropriate redetermination can be performed by considering the intention of the correction instruction.

As an example in which the intention of the correction instruction can be grasped, there is absorption of notation distortion. For example, as in the example of FIG. 6, it is assumed that an inference result that a candidate item of “having been hospitalized due to diabetes” is associated with a related notification item of “Has been hospitalized due to diabetes within 5 years” is obtained. In this case, for example, even if the applicant inputs a correction instruction such as “only visit hospital” or “hospitalization is over 10 years ago” different from “not hospitalized due to diabetes” as in the example of FIG. 6, the result of re-inference can be determined as “not associated with the notification item”.

In a case where a correction instruction representing a correction content in a natural language is received, there is also an advantage that the content of the correction instruction can be reflected in other inferences. For example, it is assumed that a correction instruction of “there is no hospital facility in X clinic” is input in response to an inference result that a candidate item of “diagnosed as diabetes in X clinic” is associated with a related notification item of “Has been hospitalized due to diabetes within 5 years”. In this case, the determination unit 103A can not only correct the inference result regarding the candidate item to “not associated with the notification item”, but also update other inference results based on the fact that there is no hospital facility in the X clinic.

### Reuse of Correction Instruction

The content of the correction instruction as described above may be recorded in the storage unit 11A or an external database or the like and used for the subsequent inference. For example, a comment of a correction instruction “There is no hospital facility in X clinic” may be recorded, and this comment may be used for inference about other candidate items. As a result, in the subsequent inference (only inference for the same applicant may be used, or inference for other applicants may be used), it is possible to obtain an inference result based on the fact that there is no hospital facility in the X clinic.

The presentation control unit 104A may present the recorded content of the correction instruction to the applicant, and the reception unit 105A may receive correction, deletion, addition, or the like of the content of the correction instruction. As a result, the content of the correction instruction according to the intention of the applicant can be reflected in the subsequent inference without relearning the language model M2 or the like. The correction instruction may be reused by including the correction instruction in the prompt as in the case where the correction instruction is used for the first time. That is, the determination unit 103A may generate a prompt that includes the recorded correction instruction and instructs to infer the relationship between the candidate item and the related notification item based on the correction instruction, input the generated prompt to the language model M2, and output an inference result indicating whether the candidate item is associated with the related notification item.

### Repetition of Inference

Since the language model M2 is a probabilistic model, inference results in a plurality of inferences can be different from each other even in a case where exactly the same prompt is input. In particular, it is known that there is a tendency that an inference result different from the fact is hardly repeatedly output. Therefore, the determination unit 103A may perform processing of inputting a prompt to the language model M2 and outputting the inference result a plurality of times. In this case, the determination unit 103A may determine that a candidate item having a large variation in the inference result is not associated with the related notification item. For example, the determination unit 103A may calculate a score (for example, a ratio of inference results having different contents from other inference results to all the inference results) indicating the magnitude of the variation in the inference result for each candidate item, and determine that a candidate item whose calculated score exceeds a predetermined threshold is not associated with the related notification item.

### Regarding Confirmation as to Presence of Input Omission

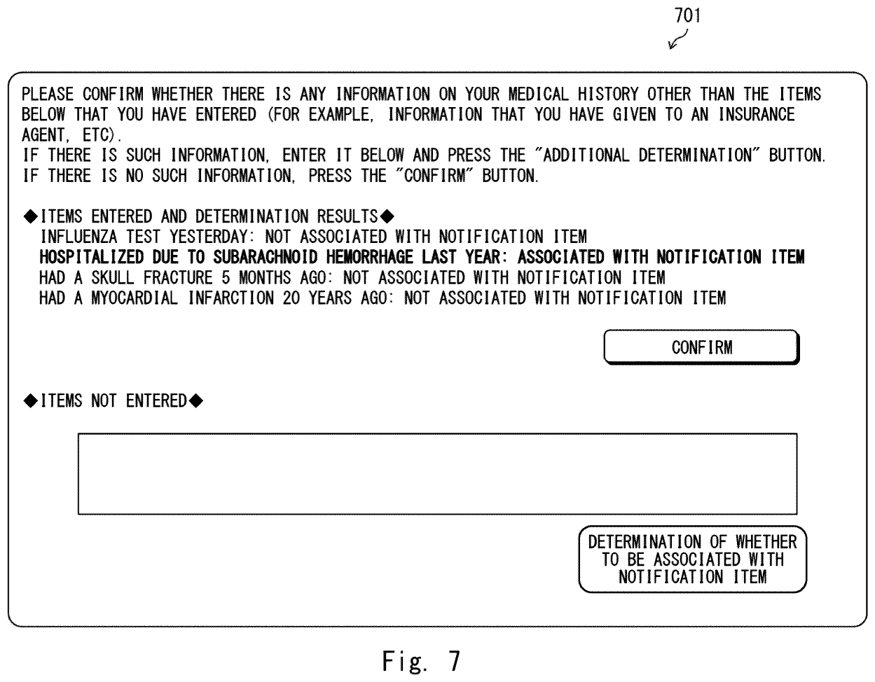

As described above, if an insurance contract is concluded in a state where there is a failure to notify any notification items, there is a possibility that an insurance money cannot be received. Therefore, the information processing apparatus 1A may prompt the applicant to confirm whether there is no omission in the notification item. This will be described with reference to FIG. 7. FIG. 7 is a diagram illustrating an example of a UI screen to be presented for prompting confirmation of input omission.

The screen example 701 illustrated in FIG. 7 illustrates each candidate item indicated in the notification information acquired by the acquisition unit 101A, and a determination result as to whether the candidate item is associated with the related notification item. The screen example 701 illustrates a text prompting confirmation of whether there is information such as a medical history other than the above candidate items, and input if there is such information. The screen example 701 also displays a text box for inputting an unentered item (candidate item) and a button (software key) for instructing determination as to whether the item is associated with a notification item, in addition to a button (software key) for confirming notification contents.

The presentation control unit 104A presents a UI screen such as the screen example 701 to the applicant in such a way that the applicant can confirm whether there is an input omission. In particular, there are not a few cases where a person misunderstands that he/she has performed the obligation to notify the insurance agent or the like and omits the notification, and thus, a sentence prompting the applicant to input the items that have been communicated to an insurance agent or the like may be presented as in the screen example 701.

In a case where the button for confirming the notification content is operated in the screen example 701, the input support unit 106A confirms the candidate item determined by the determination unit 103A to be associated with the related notification item at that time as the notification item of the insurance that the applicant intends to contract with.

On the other hand, in a case where a new candidate item is input into the text box and a button for instructing determination as to whether the candidate item is associated with a notification item is operated, the acquisition unit 101A acquires the input new candidate item as new notification information. Thereafter, similarly to the case where the notification information is acquired earlier, extraction of related notification item by the extraction unit 102A and determination by the determination unit 103A are performed, and a determination result as to whether a new candidate item is associated with the notification item is presented.

### Use of History Information

The notification information acquired by the acquisition unit 101A may be an input of an item that the applicant considers as possibly associated with the notification item, may be history information of a disease or the like of the applicant, or may be both of them. Here, in a case where the acquisition unit 101A acquires both the information input by the applicant and the history information as the notification information, there may be a case where an item that is not indicated in the information input by the applicant but may be associated with the notification item is included in the history information.

Therefore, the acquisition unit 101A may perform processing of acquiring candidate item from the information input by the applicant, acquiring candidate item from the history information, and matching the candidate item. Then, in a case where a candidate item that has not been acquired from the information input by the applicant but has been acquired from the history information is detected by the above processing, the presentation control unit 104A may present the candidate item to the applicant to prompt the applicant to input whether to perform notification. As a result, it is possible to supplement the information input by the applicant and perform notification without omission.

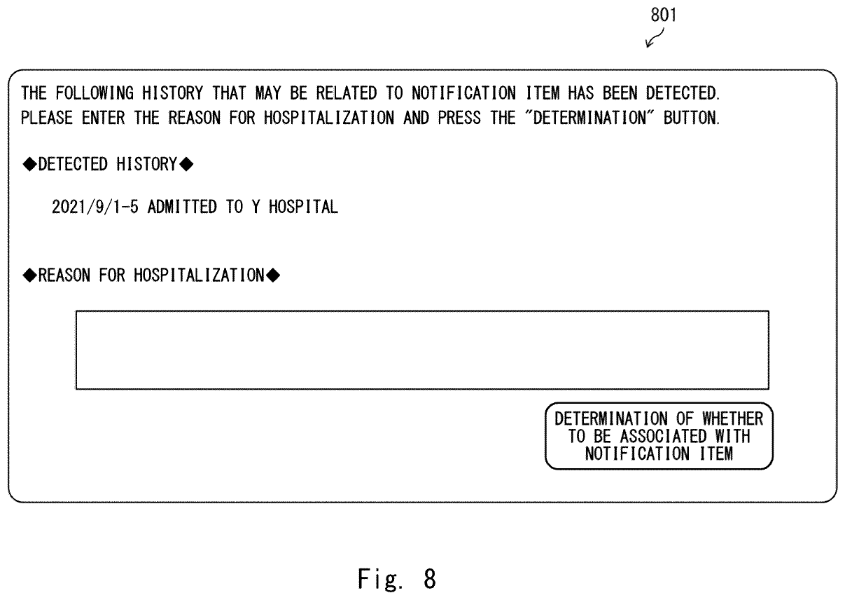

There is a possibility that the history information acquired by the acquisition unit 101A does not include sufficient information for determining whether each item indicated in the history information is associated with the notification item of the insurance. Therefore, the presentation control unit 104A may present the candidate item acquired from the history information to the applicant to prompt the input of information for determining whether the candidate item is associated with the notification item. This will be described with reference to FIG. 8.

FIG. 8 is a diagram illustrating an example of a UI screen that receives an input of an explanatory sentence of history information. In the screen example 801 illustrated in FIG. 8, a text indicating that the history information possibly related to the notification item has been detected is displayed, and the detected history information is displayed. Specifically, this history information indicates that the patient was admitted to the Y hospital in the period from September 1 to 5 days in 2021.

The screen example 801 displays a text prompting the user to input the reason for the hospitalization and to press the “determination of whether to be associated with notification item” button. Furthermore, the screen example 801 also displays a text box for inputting a reason for hospitalization and a button (software key) for instructing determination as to whether the item indicated in the history information is associated with a notification item, in consideration of the reason for the input. The reception unit 105A can receive an input of a reason for hospitalization via such a UI screen.

In the screen example 801, if the reason for hospitalization is input in the text box and the “determination of whether to be associated with notification item” button is operated, the extraction of related notification item by the extraction unit 102A is performed. In this case, the extraction unit 102A extracts a related notification item related to the candidate item by regarding a set of the detected history information and the input reason for hospitalization as one candidate item. For example, in a case where the inputted reason for hospitalization is “heart failure”, the extraction unit 102A inputs a sentence “2021/9/1-5: hospitalized in Y hospital, reason for hospitalization: heart failure” as a candidate item to the extraction model M1, and extracts a related notification item. Thereafter, a determination is made by the determination unit 103A, and a determination result as to whether the item indicated in the history information is associated with the notification item is presented.

In the example of FIG. 8, the detected history information indicates a history of hospitalization. Therefore, the reception unit 105A receives an input of a reason for hospitalization. As described above, the reception unit 105A only needs to receive input of additional information associated with the content of the history information, in other words, an explanatory sentence describing the history information. For example, in a case where history information indicating a prescription history of a medicine is detected, the reception unit 105A may receive an input of an explanatory sentence for the prescribed medicine.

As described above, the information processing apparatus 1A includes the presentation control unit 104A that presents history information of an applicant regarding a notification item, and the reception unit 105A that accepts input of an explanatory sentence describing the presented history information. Then, the extraction unit 102A extracts a related notification item related to the candidate item by using a set of the history information and the explanatory sentence as one candidate item. As a result, in addition to the effect obtained by the information processing apparatus 1, it is possible to extract an appropriate related notification item in consideration of the input explanatory sentence. The determination unit 103A may determine whether the candidate item including the history information and the explanatory sentence is associated with a related notification item using the language model M2. As a result, it is possible to obtain an appropriate determination result in consideration of the input explanatory sentence.

### Flow of Processing

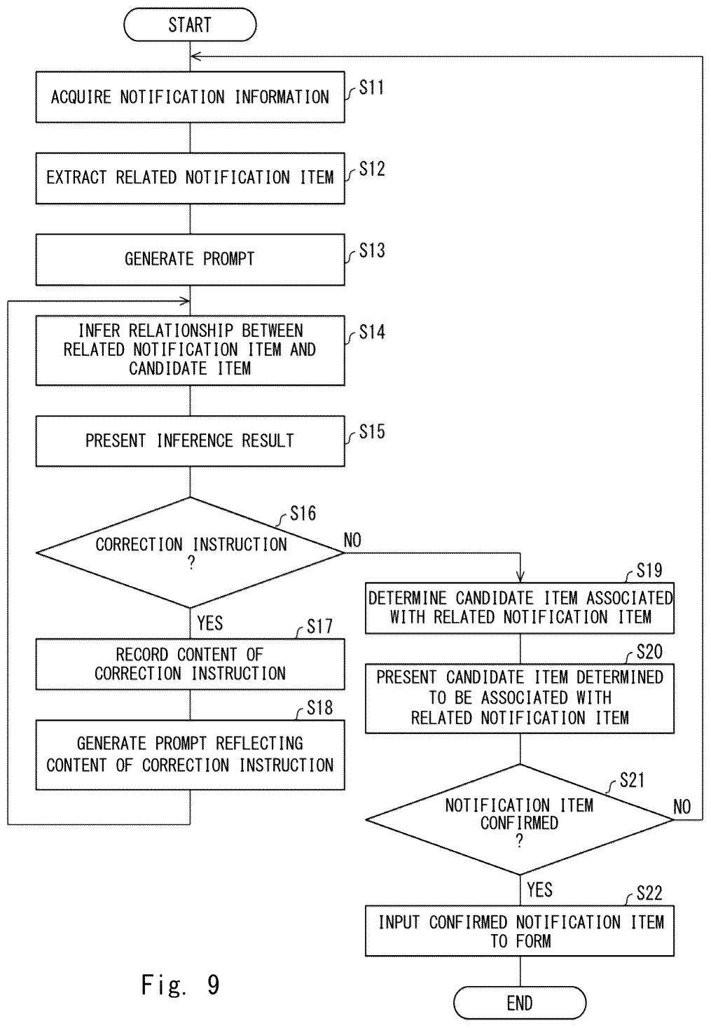

A flow of processing executed by the information processing apparatus 1A will be described with reference to FIG. 9. FIG. 9 is a flowchart illustrating a flow of processing executed by the information processing apparatus 1A. The flowchart of FIG. 9 includes each processing of the support method according to the present exemplary example embodiment.

In S11 (acquisition processing), the acquisition unit 101A acquires notification information indicating candidate item that may be associated with notification item that should be notified by the applicant of the insurance contract at the time of the contract. For example, the acquisition unit 101A may acquire notification information input by the applicant to the information processing apparatus 1A.

In S12 (extraction processing), the extraction unit 102A extracts a related notification item, which is a notification item related to the candidate item indicated in the notification information acquired in S11, from the document in which the notification item of the insurance is described using the extraction model M1 machine learned in such a way as to output a portion related to the data in the document using the set of document and data as an input. The document describing the notification item of the insurance may be input together with the notification information in S11, or may be acquired from a predetermined database as in the example of FIG. 4.

In S13, the determination unit 103A generates a prompt to be input to the language model M2. Specifically, the determination unit 103A generates a prompt that includes the related notification item extracted in S12 and the candidate item indicated in the notification information acquired in S11 and instructs to infer the relationship between the related notification item and the candidate item, in other words, whether the candidate item is associated with the related notification item.

In S14, the determination unit 103A inputs the prompt generated in S13 to the language model M2 to infer the relationship between the related notification item and the candidate item. In S15, the presentation control unit 104A presents the inference result of S14 to the applicant. In S16, the reception unit 105A determines whether there is a correction instruction for the inference result presented in S15. If YES is determined in S16, the processing proceeds to S17, and if NO is determined in S16, the processing proceeds to S19.

In S15, the presentation control unit 104A may present the inference result by displaying a UI screen such as the screen example 503 of FIG. 5 or the screen example 601 of FIG. 6, for example. In this case, the reception unit 105A may receive the correction instruction via the UI screen. The processing of presenting the inference result may be omitted. In that case, after S14, the processing proceeds to S19.

In S17, the reception unit 105A records the content of the received correction instruction in the storage unit 11A, an external database, or the like. Any timing of recording the content of the correction instruction is applicable. For example, the reception unit 105A may record the content of the correction instruction after the determination described later is completed or after the application for the insurance is completed.

In S18, the determination unit 103A generates a prompt reflecting the content of the correction instruction received by the reception unit 105A, specifically, a prompt including the correction instruction and instructing to infer the relationship between the candidate item and the related notification item based on the correction instruction. Thereafter, the processing returns to S14, and the determination unit 103A inputs a newly generated prompt to the language model M2 to infer the relationship between the candidate item and the related notification item.

In S19, the determination unit 103A determines a candidate item associated with the related notification item extracted in S12 among the candidate item indicated in the notification information acquired in S11 based on the inference result of the language model M2 (the latest inference result among the plurality of inference results in a case where the inference is performed a plurality of times).

In S20, the presentation control unit 104A presents the candidate item determined to be associated with the related notification item in S19 to the applicant as an item that the applicant should notify. For example, the presentation control unit 104A may present the inference result by displaying a UI screen such as the screen example 701 of FIG. 7.

In S21, the input support unit 106A determines whether a notification item has been confirmed. For example, in a case where the “confirm” button in the screen example 701 of FIG. 7 is operated, the input support unit 106A may determine that all the candidate items determined to be associated with the related notification item in S19 have been confirmed as the notification item.

If YES is determined in S21, the processing proceeds to S22. On the other hand, if NO is determined in S21, the processing returns to S11. In S11 proceeding from S21, the acquisition unit 101A acquires new notification information. For example, in a case where a UI screen such as the screen example 701 of FIG. 7 is displayed in S20, the acquisition unit 101A may acquire an item input as a non-input item via the UI screen as new notification information.

In S22, the input support unit 106A inputs each candidate item determined to be confirmed as a notification item in S21 to the input form of the insurance to be contracted by the applicant. If there is no candidate item determined to be associated with the related notification item, the input support unit 106A inputs that there is no notification item to the input form. Accordingly, the processing of FIG. 10 ends. In S22, the input support unit 106A may transmit the input form to a predetermined transmission destination to advance the insurance contract.

As described above, the inference result of the language model M2 is not necessarily correct. Therefore, the input support unit 106A may also input the notification information acquired in S11 and the inference result in S14 to the input form as reference information. In a case where the inference basis is output together with the inference result, the input support unit 106A may also input the inference basis as reference information. As a result, an underwriter who determines whether to underwrite the insurance contract can appropriately determine whether to purchase the insurance contract in consideration of the reference information.

In a case associated with the notification item, the insurance fee may be higher than expected by the applicant, or the underwriting of the insurance may be refused. Therefore, in a case where there is a candidate item determined to be associated with the related notification item, the presentation control unit 104A may present an insurance product for which notification of the related notification item is not a requirement.

### Reference Example 1

FIG. 10 is a block diagram illustrating a configuration of an information processing apparatus 1B according to the present reference example. As illustrated, the information processing apparatus 1B includes an acquisition unit 101B and a determination unit 103B.

Similarly to the acquisition unit 101A of the second exemplary example embodiment, the acquisition unit 101B acquires notification information indicating candidate item that may be associated with notification item that is to be notified by an applicant of an insurance contract at the time of the contract.

Similarly to the determination unit 103A of the second exemplary example embodiment, the determination unit 103B determines whether the candidate item indicated in the notification information acquired by the acquisition unit 101B is associated with a notification item by using a language model trained by machine learning on natural language.

As in the first exemplary example embodiment or the second exemplary example embodiment, the notification item may be extracted from the document in which the notification item is described using the extraction model (that is, the related notification item), or may not be extracted by the extraction model. For example, the acquisition unit 101B may acquire a notification item associated with the candidate item, in other words, a notification item for which it is desired to determine whether the candidate item corresponds, in addition to the candidate item, by causing the applicant to input the notification item or the like. For example, the determination unit 103B can extract a part of a document describing notification item of insurance (for example, a coherent portion of the content such as one sentence or one paragraph) by analyzing the document, and perform the above determination using the part.

As described above, the information processing apparatus 1B includes the acquisition unit 101B that acquires notification information indicating a candidate item that may be associated with a notification item that is an item to be notified by an applicant of an insurance contract at the time of the contract, and the determination unit 103B that determines whether the candidate item indicated in the notification information acquired by the acquisition unit 101B is associated with the notification item by using a language model trained by machine learning on natural language. According to the information processing apparatus 1B, it is possible to obtain an objective determination result as to whether a candidate item is associated with a notification item. Therefore, it is possible to obtain an effect that it is possible to support the notification of the notification item in the insurance contract in such a way as to be easily notified.

Any method of using the determination result of the determination unit 103B in facilitating notification is applicable. For example, the presentation control unit 104A similar to that of the information processing apparatus 1A according to the second exemplary example embodiment may be provided in the information processing apparatus 1B. In this case, the presentation control unit 104A can be caused to present the determination result of the determination unit 103B or the candidate item determined to be associated with the notification item by the determination unit 103B. As a result, the applicant can notify the notification item with reference to the presented determination result or candidate item.

For example, the information processing apparatus 1B may be provided with an input support unit 106A similar to the information processing apparatus 1A of the second exemplary example embodiment. In this case, the input support unit 106A can be caused to input the candidate item determined to be associated with the notification item by the determination unit 103B as the notification item. As a result, the applicant can input the notification item to the predetermined input form only by inputting the candidate item to the information processing apparatus 1B.

### Support Program

The above-described functions of the information processing apparatus 1B can also be achieved by a program. A support program according to the present reference example is a support program for application of an insurance contract, which causes a computer to function as acquisition means for acquiring notification information indicating a candidate item likely to be associated with a notification item which is an item to be notified by an applicant of an insurance contract at the time of the contract; and determination means for determining whether the candidate item indicated in the notification information acquired in the acquisition means is associated with the notification item by using a language model trained by machine learning on natural language. According to this support program, it is possible to obtain an effect that it is possible to support the notification of the notification item in the insurance contract in such a way as to be easily notified.

### Support Method

A support method according to the present reference example is a support method for application of an insurance contract, which causes at least one processor to execute acquisition processing for acquiring notification information indicating a candidate item likely to be associated with a notification item which is an item to be notified by an applicant of an insurance contract at the time of the contract; and determination processing for determining whether the candidate item indicated in the notification information acquired in the acquisition processing is associated with the notification item by using a language model trained by machine learning on natural language. According to this support method, it is possible to obtain an effect that support can be performed in such a way that notification of a notification item in an insurance contract can be easily performed.

### Reference Example 2

In the above-described exemplary example embodiment, the information processing apparatuses 1 and 1A have been described in which notification information indicating candidate items that may be associated with notification items that are item to be notified by an applicant of an insurance contract at the time of the contract is acquired, and related notification items related to the candidate items are extracted from a document in which the notification items of the insurance are described.

In the above-described reference example, the information processing apparatus 1B has been described that acquires notification information indicating candidate items that may be associated with notification items that are items to be notified by an applicant of an insurance contract at the time of the contract, and determines whether the candidate items are associated with the notification items.

These information processing apparatuses 1, 1A, and 1B can be used for generation support of any product in addition to support for notification of a notification item in an insurance contract. For example, in a case of preparing an application document for a grant, the applicant determines whether the payment requirements are satisfied, and prepares an application document indicating that the requirements are satisfied.

At this time, the applicant may input an item that may be associated with the payment requirement to the information processing apparatus 1 or 1A instead of the notification information, and may cause the information processing apparatus 1 to refer to a document describing the payment requirement instead of the document describing the notification item. As a result, it is possible to extract the requirements related to the item input by the applicant among the requirements described in the document describing the payment requirements. Then, by causing the information processing apparatus 1 or 1A to present the extracted requirement, the applicant can smoothly determine whether the requirement is satisfied and efficiently proceed with creation of the application form.

The applicant may input an item that may be associated with the payment requirement to the information processing apparatus 1B instead of the notification information, and cause the information processing apparatus 1B to refer to the payment requirement of the grant. As a result, it is possible to cause the information processing apparatus 1B to output a determination result as to whether the item input by the applicant satisfies the payment requirement. Then, the applicant can efficiently proceed with the creation of the application form with reference to the presented determination result.

In addition, for example, the information processing apparatuses 1, 1A, and 1B can also be used to create a product instruction manual conforming to the description of the specification, create a document conforming to a provision of a law, an ordinance, or the like, and the like.

### Modified Examples

Any execution subject of each processing described in the above-described exemplary example embodiment and reference example is applicable, and is not limited to the above-described examples. For example, a system having functions similar to those of the information processing apparatuses 1, 1A, and 1B can be constructed by a plurality of apparatuses capable of communicating with each other. The execution subject of each processing illustrated in the flowchart illustrated in FIG. 9 may be one device (also referred to as a processor) or a plurality of apparatuses (also referred to as a processor).

### Example of Implementation by Software

Some or all of the functions of the information processing apparatuses 1, 1A, and 1B (hereinafter also referred to as “each of the above apparatuses”) may be implemented by hardware such as an integrated circuit (IC chip) or may be implemented by software.

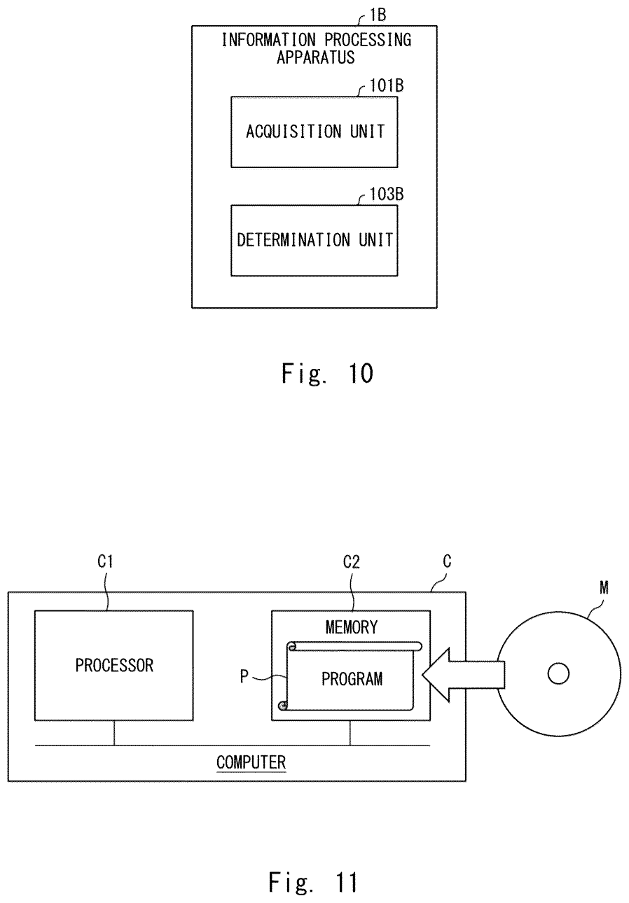

In the latter case, each of the above apparatuses is implemented by, for example, a computer that executes a command of a program which is software for implementing each function. An example of such a computer (hereinafter, referred to as a computer C) is illustrated in FIG. 11. FIG. 11 is a block diagram illustrating a hardware configuration of the computer C functioning as each of the above apparatuses.

The computer C includes at least one processor C1 and at least one memory C2. A program (support program) P for operating the computer C as each of the above apparatuses is recorded in the memory C2. In the computer C, the processor C1 reads the program P from the memory C2 and executes the program P to implement each function of each of the above apparatuses.

As the processor C1, for example, a central processing unit (CPU), a graphic processing unit (GPU), a digital signal processor (DSP), a micro processing unit (MPU), a floating point number processing unit (FPU), a physics processing unit (PPU), a tensor processing unit (TPU), a quantum processor, a microcontroller, or a combination thereof can be used. As the memory C2, for example, a flash memory, a hard disk drive (HDD), a solid state drive (SSD), or a combination thereof can be used.

The computer C may further include a random access memory (RAM) for loading the program P at the time of execution and temporarily storing various types of data. The computer C may further include a communication interface for transmitting and receiving data to and from other apparatuses. The computer C may further include an input/output interface for connecting input/output devices such as a keyboard, a mouse, a display, and a printer.

The program P can be recorded in a non-transitory tangible recording medium M readable by the computer C. As such a recording medium M, for example, a tape, a disk, a card, a semiconductor memory, a programmable logic circuit, or the like can be used. The computer C can acquire the program P via such a recording medium M. The program P can be transmitted via a transmission medium. As such a transmission medium, for example, a communication network, a broadcast wave, or the like can be used. The computer C can also acquire the program P via such a transmission medium.

Each of the above functions of each of the above apparatuses may be implemented by one processor provided in one computer, may be implemented in cooperation with a plurality of processors provided in one computer, or may be implemented in cooperation with a plurality of processors provided in a plurality of computers, respectively. The program causing each of the above apparatuses to implement each of the above functions may be stored in one memory provided in one computer, may be stored in a distributed manner in a plurality of memories provided in one computer, or may be stored in a distributed manner in a plurality of memories provided in a plurality of computers, respectively.

### Supplementary Notes

The present disclosure includes the technologies described in the following supplementary notes. However, the present invention is not limited to the techniques described in the following supplementary notes, and various modifications can be made within the scope described in the claims.

### Supplementary Note A1

An information processing apparatus including: acquisition means for acquiring notification information indicating a candidate item likely to be associated with a notification item which is an item to be notified by an applicant of an insurance contract at the time of the contract; and extraction means for extracting a related notification item, which is a notification item related to the candidate item, from a document in which the notification item of the insurance is described using an extraction model machine learned in such a way as to output a portion related to the data in the document by using a set of the document and the data as an input.

### Supplementary Note A2

The information processing apparatus according to Supplementary Note A1, further including: determination means for determining whether the candidate item is associated with the related notification item by using a language model trained by machine learning on natural language; and presentation control means for presenting the candidate item determined to be associated with the related notification item by the determination means as an item to be notified by the applicant.

### Supplementary Note A3

The information processing apparatus according to Supplementary Note A2, in which the determination means generates a prompt that includes the related notification item and the candidate item and instructs to infer a relationship between the related notification item and the candidate item, and determines whether the candidate item is associated with the related notification item based on an output obtained by inputting the generated prompt to the language model.

### Supplementary Note A4

The information processing apparatus according to Supplementary Note A3, in which the determination means generates a prompt instructing to output a basis of the inference together with an inference result of the relationship between the related notification item and the candidate item, and the presentation control means presents the inference result output by the language model or the determination result by the determination means together with the basis.

### Supplementary Note A5

The information processing apparatus according to Supplementary Note A4, further including reception means for receiving a correction instruction for the inference result, in which the determination means redetermines whether the candidate item is associated with the related notification item based on the correction instruction received by the reception means.

### Supplementary Note A6

The information processing apparatus according to Supplementary Note A5, in which the reception means receives a correction instruction representing a correction content in a natural language, and the determination means generates a prompt including a correction instruction received by the reception means and instructing to infer a relationship between the candidate item and the related notification item based on the correction instruction, and redetermines whether the candidate item is associated with the related notification item based on an output obtained by inputting the generated prompt into the language model.

### Supplementary Note A7

The information processing apparatus according to any one of Supplementary Notes A1to A6, further including: presentation control means for presenting history information on the applicant regarding the notification item; and reception means for receiving an input of an explanatory sentence describing the presented history information, wherein the extraction means extracts a related notification item related to the candidate item by using a set of the history information and the explanatory sentence as one candidate item.

### Supplementary Note A8

An information processing apparatus including: acquisition means for acquiring notification information indicating a candidate item likely to be associated with a notification item which is an item to be notified by an applicant of an insurance contract at the time of the contract; and determination means for determining whether the candidate item is associated with the notification item by using a language model trained by machine learning on natural language.

### Supplementary Note B1

A support method causing at least one processor to execute: acquisition processing of acquiring notification information indicating a candidate item that may be associated with a notification item which is an item to be notified by an applicant of an insurance contract at the time of a contract; and extraction processing of extracting a related notification item, which is a notification item related to the candidate item, from a document in which a notification item of the insurance is described using an extraction model machine learned in such a way as to output a portion related to the data in the document using a set of the document and the data as an input.

### Supplementary Note B2

The support method according to Supplementary Note B1, in which the at least one processor includes determination processing for determining whether the candidate item is associated with the related notification item by using a language model trained by machine learning on natural language, and the at least one processor includes presentation control processing for presenting the candidate item determined to be associated with the related notification item in the determination processing as an item to be notified by the applicant.

### Supplementary Note B3

The support method according to Supplementary Note B2, in which in the determination processing, the at least one processor generates a prompt that includes the related notification item and the candidate item and instructs to infer a relationship between the related notification item and the candidate item, and determines whether the candidate item is associated with the related notification item based on an output obtained by inputting the generated prompt to the language model.

### Supplementary Note B4

The support method according to Supplementary Note B3, in which in the determination processing, the at least one processor generates a prompt instructing to output a basis of the inference together with an inference result of the relationship between the related notification item and the candidate item, and in the presentation control processing, the at least one processor presents the inference result output by the language model or the determination result by the determination processing together with the basis.

### Supplementary Note B5

The support method according to Supplementary Note B4, in which the at least one processor includes reception processing for receiving a correction instruction for the inference result, and processing for redetermining whether the candidate item is associated with the related notification item based on the correction instruction received in the reception processing.

### Supplementary Note B6

The support method according to Supplementary Note B5, in which in the reception processing, the at least one processor receives a correction instruction representing a correction content in a natural language, and in the redetermination processing, the at least one processor generates a prompt including a correction instruction received in the reception processing and instructing to infer a relationship between the candidate item and the related notification item based on the correction instruction, and redetermines whether the candidate item is associated with the related notification item based on an output obtained by inputting the generated prompt into the language model.

### Supplementary Note B7

The support method according to any one of Supplementary Notes B1 to B6, in which the at least one processor includes presentation control processing for presenting history information on the applicant regarding the notification item, the at least one processor includes reception processing for receiving an input of an explanatory sentence describing the presented history information, and in the extraction processing, the at least one processor extracts a related notification item related to the candidate item by using a set of the history information and the explanatory sentence as one of the candidate items.

### Supplementary Note B8

A support method causing at least one processor to execute acquisition processing for acquiring notification information indicating a candidate item likely to be associated with a notification item which is an item to be notified by an applicant of an insurance contract at the time of the contract; and determination processing for determining whether the candidate item indicated in the notification information acquired in the acquisition processing is associated with the notification item by using a language model trained by machine learning on natural language.

### Supplementary Note C1

A support program causing a computer to function as: acquisition means for acquiring notification information indicating a candidate item that may be associated with a notification item which is an item to be notified by an applicant of an insurance contract at the time of a contract; and extraction means for extracting a related notification item, which is a notification item related to the candidate item, from a document in which a notification item of the insurance is described using an extraction model machine learned in such a way as to output a portion related to the data in the document using a set of the document and the data as an input.

### Supplementary Note C2

The support program according to Supplementary Note C1, further causing the computer to function as determination means for determining whether the candidate item is associated with the related notification item by using a language model trained by machine learning on natural language; and presentation control means for presenting the candidate item determined to be associated with the related notification item by the determination means as an item to be notified by the applicant.

### Supplementary Note C3

The support program according to Supplementary Note C2, in which the determination means generates a prompt that includes the related notification item and the candidate item and instructs to infer a relationship between the related notification item and the candidate item, and determines whether the candidate item is associated with the related notification item based on an output obtained by inputting the generated prompt to the language model.

### Supplementary Note C4

The support program according to Supplementary Note C3, in which the determination means generates a prompt instructing to output a basis of the inference together with an inference result of the relationship between the related notification item and the candidate item, and the presentation control means presents the inference result output by the language model or the determination result by the determination means together with the basis.

### Supplementary Note C5

The support program according to Supplementary Note C4, causing the computer to function as reception means for receiving a correction instruction for the inference result, in which the determination means redetermines whether the candidate item is associated with the related notification item based on the correction instruction received by the reception means.

### Supplementary Note C6

The support program according to Supplementary Note C5, in which the reception means receives a correction instruction representing a correction content in a natural language, and the determination means generates a prompt including a correction instruction received by the reception means and instructing to infer a relationship between the candidate item and the related notification item based on the correction instruction, and redetermines whether the candidate item is associated with the related notification item based on an output obtained by inputting the generated prompt into the language model.

### Supplementary Note C7

The support program according to any one of Supplementary Notes C1 to C6, causing the computer to function as presentation control means for presenting history information on the applicant regarding the notification item; and reception means for receiving an input of an explanatory sentence describing the presented history information, in which the extraction means extracts a related notification item related to the candidate item by using a set of the history information and the explanatory sentence as one of the candidate items.

### Supplementary Note C8

A support program causing a computer to function as acquisition means for acquiring notification information indicating a candidate item likely to be associated with a notification item which is an item to be notified by an applicant of an insurance contract at the time of the contract; and determination means for determining whether the candidate item indicated in the notification information acquired in the acquisition means is associated with the notification item by using a language model trained by machine learning on natural language.

### Supplementary Note D1

An information processing apparatus including at least one processor, the at least one processor executing acquisition processing of acquiring notification information indicating a candidate item that may be associated with a notification item which is an item to be notified by an applicant of an insurance contract at the time of a contract; and extraction processing of extracting a related notification item, which is a notification item related to the candidate item, from a document in which a notification item of the insurance is described using an extraction model machine learned in such a way as to output a portion related to the data in the document using a set of the document and the data as an input.

The information processing apparatus may further include a memory. The memory may store a program for causing the at least one processor to execute each of the processing.

### Supplementary Note D2

The information processing apparatus according to Supplementary Note D1, in which the at least one processor executes determination processing for determining whether the candidate item is associated with the related notification item by using a language model trained by machine learning on natural language, and presentation control processing for presenting the candidate item determined to be associated with the related notification item in the determination processing as an item to be notified by the applicant.

### Supplementary Note D3

The information processing apparatus according to Supplementary Note D2, in which in the determination processing, the at least one processor generates a prompt that includes the related notification item and the candidate item and instructs to infer a relationship between the related notification item and the candidate item, and determines whether the candidate item is associated with the related notification item based on an output obtained by inputting the generated prompt to the language model.

### Supplementary Note D4

The information processing apparatus according to Supplementary Note D3, in which in the determination processing, the at least one processor generates a prompt instructing to output a basis of the inference together with an inference result of the relationship between the related notification item and the candidate item, and in the presentation control processing, the at least one processor presents the inference result output by the language model or the determination result by the determination processing together with the basis.

### Supplementary Note D5

The information processing apparatus according to Supplementary Note D4, in which the at least one processor executes reception processing for receiving a correction instruction for the inference result, and in the determination processing, the at least one processor redetermines whether the candidate item is associated with the related notification item based on the correction instruction received in the reception processing.

### Supplementary Note D6

The information processing apparatus according to Supplementary Note D5, in which in the reception processing, the at least one processor receives a correction instruction representing a correction content in a natural language, and in the determination processing, the at least one processor generates a prompt including a correction instruction received in the reception processing and instructing to infer a relationship between the candidate item and the related notification item based on the correction instruction, and redetermines whether the candidate item is associated with the related notification item based on an output obtained by inputting the generated prompt into the language model.

### Supplementary Note D7

The information processing apparatus according to any one of Supplementary Notes D1 to D6, in which the at least one processor executes presentation control processing for presenting history information on the applicant regarding the notification item and reception processing for receiving an input of an explanatory sentence describing the presented history information, and in the extraction processing, the at least one processor extracts a related notification item related to the candidate item by using a set of the history information and the explanatory sentence as one of the candidate items.

### Supplementary Note D8

An information processing apparatus including at least one processor, the at least one processor executing acquisition processing for acquiring notification information indicating a candidate item likely to be associated with a notification item which is an item to be notified by an applicant of an insurance contract at the time of the contract; and determination processing for determining whether the candidate item indicated in the notification information acquired in the acquisition processing is associated with the notification item by using a language model trained by machine learning on natural language.

### Supplementary Note E1

A non-transitory recording medium recording a support program for causing a computer to execute acquisition processing for acquiring notification information indicating a candidate item that may be associated with a notification item which is an item to be notified by an applicant of an insurance contract at the time of a contract; and extraction processing for extracting a related notification item, which is a notification item related to the candidate item, from a document in which a notification item of the insurance is described using an extraction model machine learned in such a way as to output a portion related to the data in the document using a set of the document and the data as an input.

### Supplementary Note E2

A non-transitory recording medium recording a support program for causing a computer to execute acquisition processing for acquiring notification information indicating a candidate item likely to be associated with a notification item which is an item to be notified by an applicant of an insurance contract at the time of the contract; and determination processing for determining whether the candidate item indicated in the notification information acquired in the acquisition processing is associated with the notification item by using a language model trained by machine learning on natural language.

1. An information processing apparatus comprising:
at least one memory storing instructions; and
at least one processor configured to execute the instructions to;
acquire notification information indicating a candidate item likely to be associated with a notification item which is an item to be notified by an applicant of an insurance contract at the time of the contract; and
extract a related notification item, which is a notification item related to the candidate item, from a document in which the notification item of the insurance is described using an extraction model machine learned in such a way as to output a portion related to the data in the document by using a set of the document and the data as an input.

2. The information processing apparatus according to claim 1, the at least one processor is further configured to execute the instructions to
determine whether the candidate item is associated with the related notification item by using a language model trained by machine learning on natural language; and
present the candidate item determined to be associated with the related notification item by the determination means as an item to be notified by the applicant.

3. The information processing apparatus according to claim 2, the at least one processor is further configured to execute the instructions to
generate a prompt that includes the related notification item and the candidate item and instructs to infer a relationship between the related notification item and the candidate item; and
determine whether the candidate item is associated with the related notification item based on an output obtained by inputting the generated prompt to the language model.

4. The information processing apparatus according to claim 3, the at least one processor is further configured to execute the instructions to
generate a prompt instructing to output a basis of the inference together with an inference result of the relationship between the related notification item and the candidate item; and
present the inference result output by the language model or the determination result by together with the basis.

5. The information processing apparatus according to claim 4, the at least one processor is further configured to execute the instructions to
receive a correction instruction for the inference result; and
redetermine whether the candidate item is associated with the related notification item based on the correction instruction received.

6. The information processing apparatus according to claim 5, the at least one processor is further configured to execute the instructions to
receive a correction instruction representing a correction content in a natural language;
generate a prompt including a correction instruction received and instructing to infer a relationship between the candidate item and the related notification item based on the correction instruction; and
redetermine whether the candidate item is associated with the related notification item based on an output obtained by inputting the generated prompt into the language model.

7. The information processing apparatus according to claim 1, the at least one processor is further configured to execute the instructions to
present history information on the applicant regarding the notification item;
receive an input of an explanatory sentence describing the presented history information; and
extract a related notification item related to the candidate item by using a set of the history information and the explanatory sentence as one candidate item.

8. A support method causing at least one processor to execute:
acquisition processing of acquiring notification information indicating a candidate item that may be associated with a notification item which is an item to be notified by an applicant of an insurance contract at the time of a contract; and
extraction processing of extracting a related notification item, which is a notification item related to the candidate item, from a document in which a notification item of the insurance is described using an extraction model machine learned in such a way as to output a portion related to the data in the document using a set of the document and the data as an input.

9. A non-transitory recording medium recording a support program for causing a computer to execute acquisition processing for acquiring notification information indicating a candidate item that may be associated with a notification item which is an item to be notified by an applicant of an insurance contract at the time of a contract; and extraction processing for extracting a related notification item, which is a notification item related to the candidate item, from a document in which a notification item of the insurance is described using an extraction model machine learned in such a way as to output a portion related to the data in the document using a set of the document and the data as an input.
